(19) United States
(12) Patent Application Publication
(10) Pub. No.: US 2025/0281784 A1
(43) Pub. Date: Sep. 11, 2025

(54) FIRE EXTINGUISHING SYSTEM FOR HYDROCARBON OR PETROCHEMICAL STORAGE TANK WITH FLOATING ROOF

(71) Applicant: SAUDI ARABIAN OIL COMPANY, Dhahran (SA)

(72) Inventors: Ahmed Funayyikh AL-RASHDI, Dhahran (SA); Maher Maqbool SHARIFF, Dhahran (SA)

(73) Assignee: SAUDI ARABIAN OIL COMPANY, Dhahran (SA)

(21) Appl. No.: 18/596,503

(22) Filed: Mar. 5, 2024

(51) Int. Cl. A62C 31/12; A62C 31/28; A62C 35/68

(52) U.S. Cl. CPC A62C 31/12; A62C 31/28; A62C 35/68

(57) ABSTRACT

A fire extinguishing system includes a storage tank defining a vertical wall and a floating roof floating on a flammable liquid stored within the storage tank. The floating roof is vertically movable along the vertical wall in response to a level of the flammable liquid within the storage tank and a rim seal is defined circumferentially between the floating roof and the vertical wall. A foam supply conduit extends to the storage tank from a remote location and a foam diffuser is fluidly coupled to the foam supply conduit. The foam diffuser is affixed to an underside of the floating roof and submerged in the flammable liquid. The foam diffuser includes at least one outlet for discharging a foam into the flammable liquid adjacent the underside of the floating roof and an upper surface of the flammable liquid.

### FIELD OF THE DISCLOSURE

The present disclosure relates generally to fire suppression and extinguishment, and more particularly, to systems for extinguishing fires in storage tanks having a roof floating on a flammable liquid stored within the tanks.

### BACKGROUND OF THE DISCLOSURE

Industrial storage tanks for petrochemical fuels such as aviation fuel, gasoline, crude oil, diesel, kerosene, heptane, naphtha and other flammable liquids often include a roof that floats on the liquids being stored within the tank. As the level of liquid within the tank fluctuates, the floating roof moves up or down while a rim seal at an outer perimeter of the floating roof maintains sliding contact with vertical walls of the tank. The floating roof helps to minimize losses of the liquids due to evaporation, and also helps to maintain regulatory compliance on pollution or emissions.

Often, vapors from the flammable liquids pass through vents provided in the floating roof so that pressure does not build up within the storage tank, or the vapors escape through damaged portions of the rim seal and are exposed to the atmosphere. Lightning or another ignition source may then ignite the vapors and create a dangerous rim seal fire above the floating roof.

Fire suppression systems for combatting rim seal fires often include nozzles positioned on the roof for directing foam, triflouoroiodomethane (CF3I) gas or another extinguishing fluid onto portions of the rim seal where a fire is detected. In some instances, the fluid directed through the nozzles may be stored on the roof in limited quantities and these systems may not be useful in the event a fire spreads beyond the rim seal. Firefighting efforts may then be prolonged, resulting increased risk to equipment and personnel as well as causing significant interruptions in the energy supply chain.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure a fire extinguishing system includes a storage tank defining a vertical wall for retaining a flammable liquid therein and a floating roof circumscribed by the vertical wall. The floating roof is movable vertically along the vertical wall in response to a changing level of the flammable liquid within the storage tank. A rim seal is defined circumferentially between the floating roof and the vertical wall and a foam supply conduit extends to the storage tank from a remote location. A foam diffuser is fluidly coupled to the foam supply conduit and affixed to an underside of the floating roof. The foam diffuser includes at least one outlet for discharging a foam from the foam supply conduit into the flammable liquid adjacent the underside of the floating roof and an upper surface of the flammable liquid.

According to another embodiment consistent with the present disclosure, a method of extinguishing a fire includes (a) installing a foam supply conduit extending from a remote location to a foam diffuser affixed to an underside a floating roof circumscribed by a vertical wall of a storage tank in which a flammable liquid is stored, (b) releasing a foam concentrate into the foam supply conduit from a foam supply in response to detecting the fire, (c) discharging the foam from the diffuser into the flammable liquid and (d) forming a protective foam blanket between the underside of the floating roof and an upper surface of the flammable liquid to extinguish the fire.

According to still another embodiment consistent with the present disclosure, a fire extinguishing system includes a storage tank defining a vertical wall, and a flammable liquid stored within the storage tank and a floating roof floating on an upper surface of the flammable liquid and circumscribed by the vertical wall. The floating roof is movable vertically along the vertical wall in response to a changing level of the flammable liquid within the storage tank. A rim seal is defined circumferentially between the floating roof and the vertical wall and a foam supply is provided at a remote location with respect to the storage tank. A foam supply conduit extends to the storage tank from the foam supply at the remote location and a foam diffuser is fluidly coupled to the foam supply conduit. The foam diffuser is submerged in the flammable liquid and affixed to an underside of the floating roof. The foam diffuser includes a backflow preventer for preventing flow of the flammable liquid into the foam supply conduit and at least one outlet for discharging a foam from the foam supply conduit into the flammable liquid adjacent the underside of the floating roof and an upper surface of the flammable liquid.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a perspective view of a fire extinguishing system for a storage tank with a floating roof in accordance with aspects of the present disclosure.

FIG. 2 is a partial, cross-sectional perspective view of the fire extinguishing system of FIG. 1 illustrating a foam supply conduit including a foam agitator, and a submerged foam chamber coupled to an underside of the floating roof.

FIG. 3 is an enlarged perspective view of the foam chamber of FIG. 2 coupled to an adjustable-length portion of the foam supply conduit.

FIG. 4 is an enlarged perspective view of the foam agitator of FIG. 2.

FIGS. 5A and 5B are perspective views of alternative embodiments of adjustable-length conduits in accordance with aspects of the present disclosure.

FIGS. 6A and 6B are cross-sectional views of the fire extinguishing system of FIG. 1, respectively, in a first configuration where fire extinguishing procedure is in process and a second configuration where the fire extinguishing operation is complete and a foam blanket is established under the floating roof in accordance with aspects of the present disclosure.

FIG. 7 is flowchart illustrating an example procedure for performing a fire extinguishing operation according to aspects of the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to a fire extinguishing system for a storage tank with a floating roof. The system includes a foam supply pipe extending from the storage tank and having a remote connection to a fire department supply, e.g., a foam tanker or another source of a foam concentrate. Various types of foam may be fed into the foam supply pipe including a low expansion protein foam, aqueous film forming foam, film forming fluoro-protein foam or a synthetic foam. A foam agitator may be placed within the foam supply pipe to inject air and mechanically agitate the foam concentrate to expand the foam. The foam supply pipe may extend downward from a tank dike to the floating roof through a variable length conduit, which may accommodate the changing height of the floating roof. The variable length conduit may be constructed as a telescoping pipe, bellows or helical spring and may be coupled to a foam chamber or diffuser disposed on an underside of the floating roof. The foam chamber may include a backflow mechanism to prevent flow of a flammable liquid in which the foam chamber is submerged into the foam supply pipe. When a foam concentrate is introduced into the foam supply pipe, a finished foam may be released directly on an upper surface of the flammable liquid to form a protective foam blanket between the flammable liquid and the floating roof, thereby robustly and efficiently extinguishing fires.

FIG. 1 illustrates a fire extinguishing system 100 for a storage tank 102 with a floating roof 104 in accordance with aspects of the present disclosure. The storage tank 102 may be surrounded by a dike 106 that forms a basin 108 sized to contain the contents of the storage tank 102 in the event of a spill or rupture. The storage tank 102 defines a generally cylindrical vertical wall 110 that may extend to a height of 40 feet or more above the basin 108. Although the wall 110 is described herein as a cylindrical vertical wall, the wall may define other shapes without departing from the scope of the disclosure. A staircase 112 extends up an exterior of the cylindrical vertical wall 110 to an elevated walkway 114 that provides access to the floating roof 104 or other structures at the top of the storage tank 102.

The floating roof 104 includes a rim seal 116 extending around a circumference thereof and engaging with an interior of the cylindrical vertical wall 110. The rim seal 116 may be constructed of elastomeric or fabric wipers, inflatable or foam filled tubular chambers or other structures recognized in the art.

The fire extinguishing system 100 generally includes a foam supply conduit 120 extending from a first end 120a to which a foam supply 124 may be coupled. In some embodiments, the first end 120a of the foam supply conduit 120 may be positioned outside the dike 106 to facilitate connection with a foam supply 124 provided by a fire department or similar service. In other embodiments, the foam supply 124 may include a permanently installed vessel that remains coupled to the foam supply conduit 120 leading to one or more storage tanks 102. A valve 128 may be provided at the first end 120a of the foam supply conduit 120. The valve 128 may be closed to prohibit flow through the foam supply conduit 120 and opened to permit flow from the foam supply 124 at the first end 120a to a second end 120b of the foam supply conduit disposed generally at the floating roof of the storage tank 102.

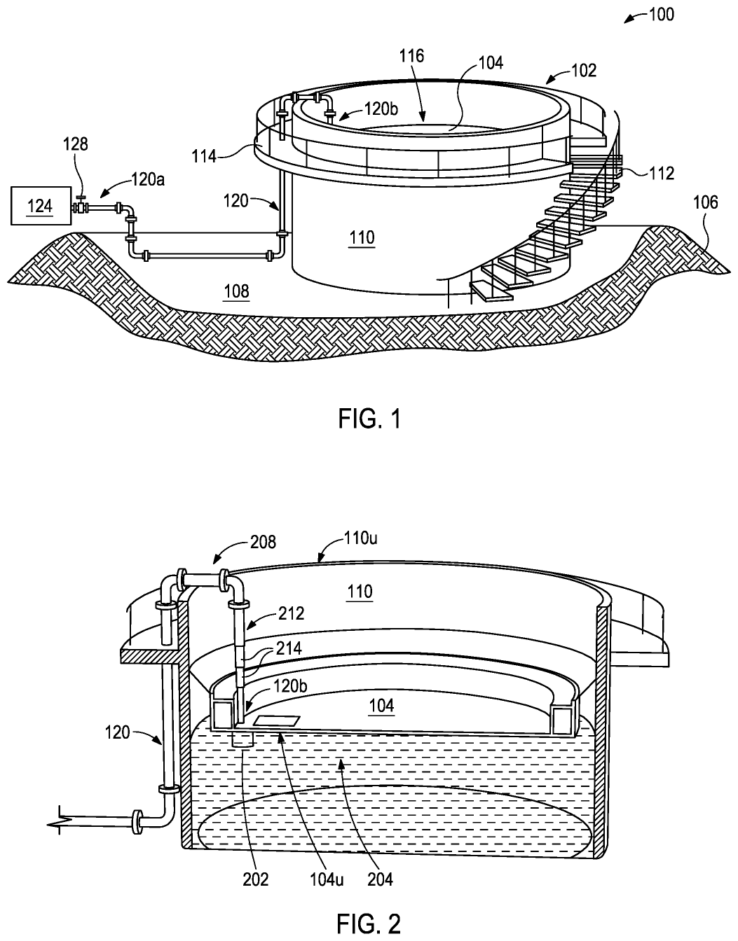

FIG. 2 illustrates the second end 120b of the foam supply conduit 120 extending over the cylindrical vertical wall 110 to the floating roof 104. A foam diffuser 202 is coupled to the end of the foam supply conduit 120 on an underside 104u of the floating roof 104. The foam diffuser 202 is submerged in a flammable liquid 204 stored within the storage tank 102, and is secured to the underside 104u of the floating roof 104. The foam diffuser 202 is positioned to facilitate an even distribution of foam between the underside 104u of the floating roof and the flammable liquid 204. Although FIG. 2 illustrates only one foam diffuser 202, in other embodiments, a plurality of foam diffusers 202 may be supported on the underside 104u of the floating roof 104 without departing from the scope of the disclosure.

Because the foam diffuser 202 is submerged in the flammable liquid 204 and is not exposed to the atmosphere, mixing air and/or water into the foam at the diffuser 202 may be challenging. Thus, a foam agitator 208 is coupled within the foam supply conduit 120 above or outside the floating roof 104. The foam agitator 208 is illustrated as extending across an upper end 110u of the cylindrical vertical wall 110, but the foam agitator 208 may be arranged in other exterior positions in other embodiments. The foam agitator 208 may operate generally to introduce air and to disrupt the flow of foam flowing through the foam supply conduit 120, as described in greater detail below.

The height of the floating roof 104 within the cylindrical vertical wall 110 may change due to temperature changes, the addition or consumption (extraction) of the flammable liquid 204 from the tank 102 or other dynamic operational conditions. Thus, the foam supply conduit 120 includes an adjustable-length portion 212 extending between the floating roof 104 and the upper end 110u of the cylindrical vertical wall to accommodate the movement of the floating roof 104. As illustrated in FIG. 2, the adjustable-length portion 212 includes a plurality of telescoping segments 214, but other arrangements are also contemplated as described in greater detail below.

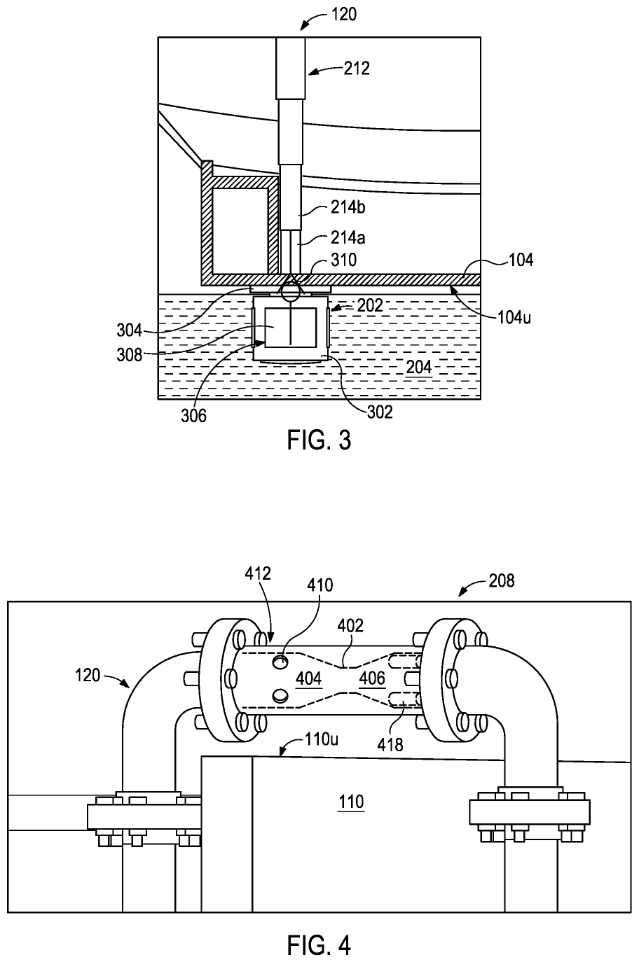

FIG. 3 illustrates the foam diffuser 202 and the adjustable-length portion 212 of the foam supply conduit 120 in greater detail. The foam diffuser 202 includes a generally cylindrical housing 302 fluidly coupled to the foam supply conduit 102. A flange 304 is provided at an upper end of the housing 302, which abuts the underside 104u of the floating roof 104 and facilitates coupling thereto. The housing 302 includes one or more outlets 306 through which foam may be discharged into the flammable liquid 204. The outlets 306 may be covered with a screen 308, such as a perforated panel or wire mesh, such that the foam may be further agitated as it enters the flammable liquid 204. The diffuser 202 may include a check valve 310 or another backflow preventer therein such that the flammable liquid 204 may not enter the foam supply conduit 120 when foam is not being pumped therethrough.

In some embodiments, the check valve 310 may extend into a lowermost segment 214a of the adjustable-length portion 212 of the foam supply conduit 120. The lowermost segment 214a may be may be fixedly coupled to the foam diffuser 202 though the floating roof 104. As the floating roof 104 moves upward, the lowermost segment 214a may be received into an adjacent segment 214b, and when the floating roof 104 moves downward the lowermost segment 214a may extend from the adjacent segment 214b. In this manner, the segments 214 of the adjustable-length portion 212 of the foam supply conduit 120 accommodate the motion of the floating roof 104.

Referring to FIG. 4, the foam agitator 208 is illustrated extending over the cylindrical vertical wall 110. The foam agitator 208 is fluidly coupled within the foam supply line 120 and defines a central flow passage 402 extending longitudinally therethrough. The central flow passage 402 may include converging and diverging portions 404, 406 to define a Venturi flow path through the foam agitator 208. As foam is pumped through the central flow passage 402, the foam may draw atmospheric air into the central flow passage 402 through lateral openings 410 defined through a sidewall 412 of the foam agitator 208. The air may facilitate aspirating and expanding the foam as it moves through the foam supply line 120. Internal fins 418 or other structures may be provided to protrude within central flow passage 402. The internal fins 418 may further agitate and expand the foam to create a high quality foam from a concentrate pumped into the foam supply line.

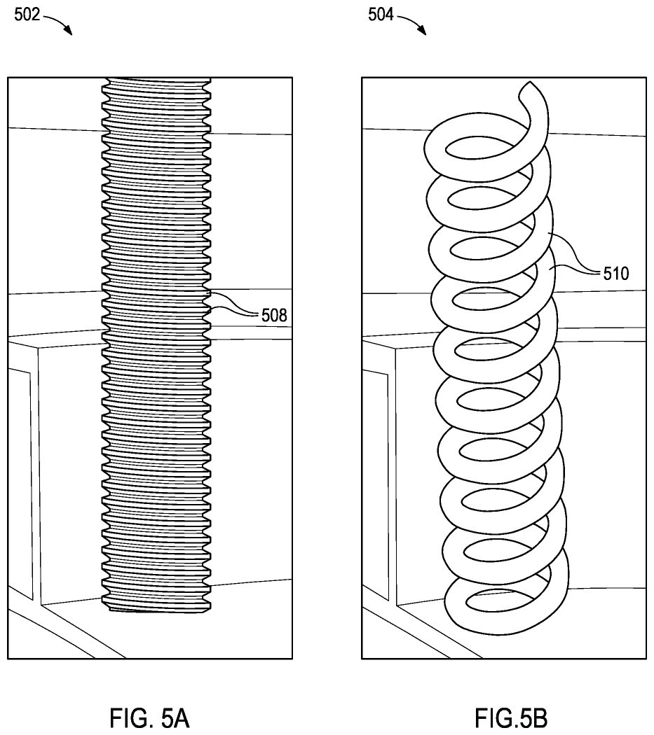

FIGS. 5A and 5B illustrate alternate embodiments of adjustable-length portions 502, 504 for use in the flow supply conduit 120 (FIG. 2). The adjustable-length portion 502 of FIG. 5A is constructed as a bellows with a plurality of folds 508 defined therein. The folds 508 may expand or contract to adjust a length of the adjustable portion 502 and thereby accommodate vertical movement of the floating roof 104 (FIG. 2). Similarly, the adjustable-length portion 504 of FIG. 5B is constructed as a flexible helical pipe with a plurality of coils 510 defined therein. The coils 510 may separate and congregate to adjust a length of the adjustable portion 504 and thereby accommodate vertical movement of the floating roof 104. The adjustable-length portions 212, 502, 504 permit the foam diffuser 202 (FIG. 2) to remain in a fixed position with respect to the floating roof 104 regardless of the level of the flammable liquids 204 (FIG. 2). Thus, the adjustable-length portions 212, 502, 504 facilitate the application of foam at an effective level for extinguishing a fire.

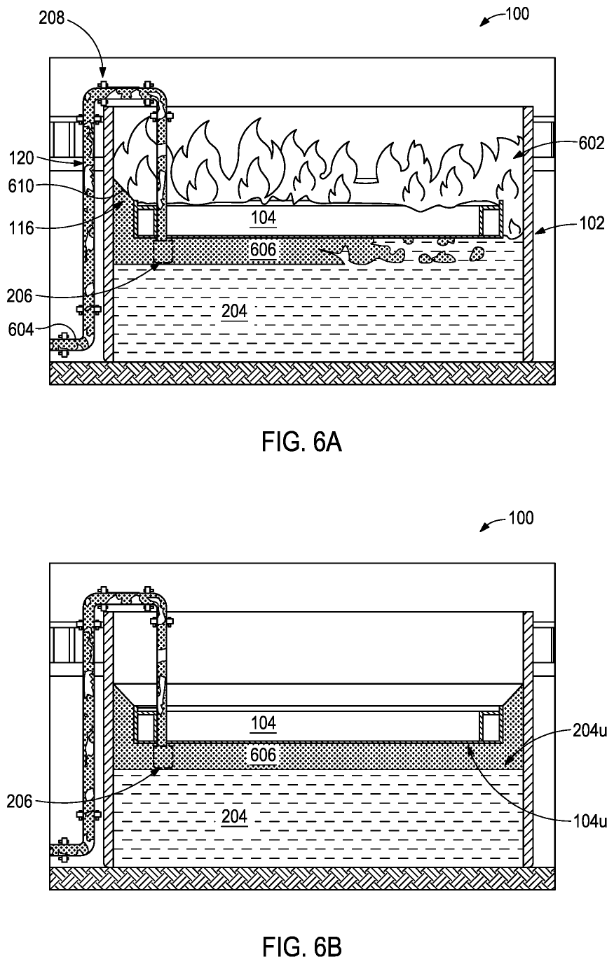

FIG. 6A illustrates the fire extinguishing system 100 in a first configuration where a fire 602 is established above the floating roof 104 and a fire extinguishing procedure is in progress. In some embodiments, the fire 602 is a rim seal fire, but in other embodiments the fire 602 may be a full surface fire extending across the floating roof 104. The fire 602 is maintained generally above the floating roof 104 where fumes from the flammable liquid 204 may have ignited in the presence of atmospheric air. In some embodiments, the fire 602 may have expanded beneath a weather shield 610 of the rim seal 116. The weather shield 610 may be constructed as an arrangement of one or more thin metal sheets pivoted from the floating roof 104 against the cylindrical vertical wall 110, and may form an uppermost seal of the rim seal 116. The weather shield 610 helps protect the flammable liquids 204 from environmental elements such as rain, sun and heat, reducing the risk of contamination and maintains the integrity of the flammable liquids 204 stored within the storage tank 102. Upon detecting the fire 602, a foam concentrate 604 is pumped or otherwise flowed in a solution with water through the foam supply conduit 120. The foam concentrate 604 is expanded within the foam agitator 208 and further expanded as it exits the foam diffuser 202 as a fully expanded foam 606.

The foam 606 may be any firefighting foam recognized in the art. Firefighting foams are generally a stable mass of small air-filled bubbles, which have a lower density than water, oil, gasoline or any of the flammable liquids 204 stored within the storage tank 102. The foam 606 may include water, foam concentrate 604 and air. When mixed in the correct proportions, these three ingredients form a homogeneous foam blanket. In some embodiments, the specific gravity (SG) of the foam 606 may be in the range of about SG=0.0501 (Density of 50 kg/m³) to about SG=0.401 (Density of 400 kg/m³). The specific gravity (SG) of hydrocarbons or other flammable liquids 204 occupying the storage tank 102 may be about SG=0.883 (° API of 28.7) for benzene, SG=0.665 (° API of 81.3) for n-hexane. Examples of other hydrocarbon fuels that may be stored within the storage tank 102 include, but are not limited to: Gasoline, Diesel, Jet Propellant (JP4), Kerosene, Heptane, and Naptha. Because the specific gravity is much higher for the flammable liquids 204 than for the foam 606, the foam 606 floats on the flammable liquid forms a protective blanket over the flammable liquids 204.

There are several types of low expansion foams, e.g., foams that expand up to 20 times in volume, which may be used as the foam 606. For example, foam 606 may include a protein foam (PF), which may have a protein base with stabilizing additives, an aqueous film forming foam (AFFF), which may have a fluorinated surfactant with stabilizing additives and synthetic surfactant foaming agents and/or a film forming flouoro-protein foam (FFFP), which may have a protein base with one or more fluorinated surfactant additives. The PF, AFFF and FFFP foams may be suitable for class A and class B fires. The foam 606 may also include a synthetic foam with a non-fluoro surfactant base concentrate and non-hydrolyzed protein, which may suitable for only class A fires.

As illustrated in FIG. 6B, the fire extinguishing system 100 is in a second configuration where the foam 606 has been fully applied beneath the floating roof 104 forming a protective blanket over the flammable liquids 204. By applying the foam through the foam diffuser 202 coupled to the underside 104a of the floating roof 104 and submerged in the flammable liquids 204, the foam 606 may be effectively distributed into a foam blanket that may ultimately extinguish the fire 602 (FIG. 6A). Because of the lower specific gravity of the foam 606 with respect to the flammable liquids 204, the foam 606 swiftly floats above an upper surface 204u of the flammable liquid 204 and right below the floating roof 104. The foam 606 fully occupies the space between the flammable liquid 204 and the solid surface of the underside 104a of the floating roof 104, extinguishing the fire 602 in a reliable, robust and efficient manner. Although FIG. 6B illustrates only a blanket of foam 606 beneath the floating roof 104, is will be appreciated by those skilled in the art that foam 606 or other fire suppressants may additionally be dispensed onto the rim seal 116 and/or upper exterior surfaces of the floating roof 104 to form an exterior foam blanket as well.

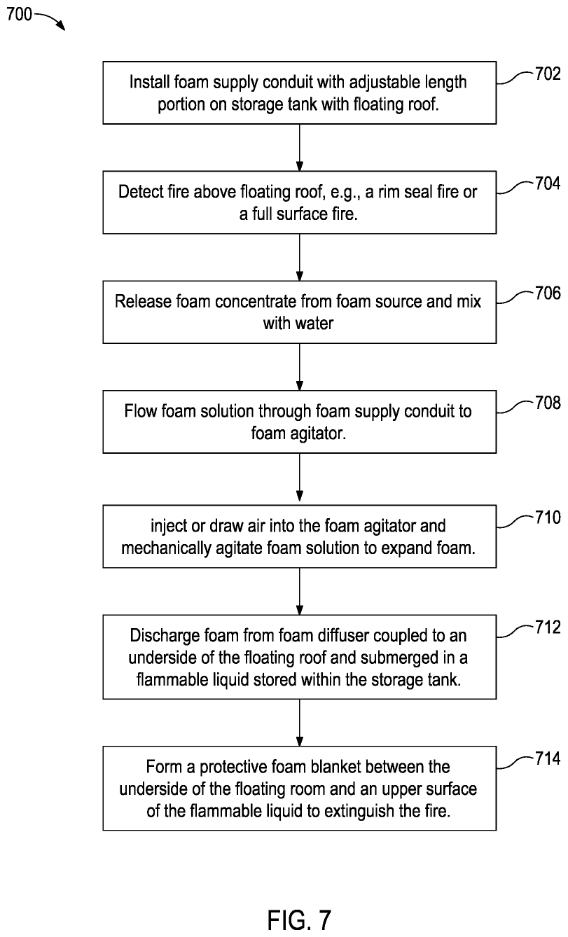

With reference to FIG. 7, and with continued reference to FIGS. 1 through 6B, an example procedure 700 is illustrated for performing a fire extinguishing operation according to aspects of the present disclosure. Initially at 702, a foam supply conduit 120 is installed on a storage tank 102 with a floating roof 104 to form a fire extinguishing system 100. The foam supply conduit 120 may extend over an upper end 110u of a cylindrical vertical wall 110 of the storage tank 102, and may have an adjustable-length portion 212 extending between the upper end 110u of the cylindrical vertical wall 110 and the floating roof. The adjustable-length portion 212 may be passively adjustable in length in response to changing levels of a flammable liquid stored within the storage tank 102.

At step 704, a fire such as a rim seal fire or a full surface fire may be detected on the floating roof 104. In some embodiments, the fire may be detected by monitoring equipment positioned on the floating roof 104 and/or the cylindrical vertical wall 110, and in other embodiments, the fire may be observed by an operator. At step 706, a foam concentrate 604 or a foam concentrate 604 mixed with water may be released from a foam supply 124 in response to detecting the fire 602 at step 704. In some embodiments, a fire department may connect the foam supply 124 to the foam supply conduit 120, and in other embodiments, a pre-connected initial foam supply 124 may be released automatically or semi-automatically in response to detecting the fire 602, and thereafter, a fire department foam tanker may be connected to augment the foam supply 124.

The foam concentrate 604 or solution of foam concentrate with water flows through the foam supply conduit 120 to a foam agitator 208 coupled within the foam supply conduit 120 (step 708). Next, at step 710, air may be injected or drawn into the foam agitator 208 using the Venturi Principle and the flow of the foam concentrate 604 through the foam agitator 208. The foam concentrate may also be mechanically agitated with fins 418 or other mechanisms within the foam agitator 208. The foam concentrate 604 may thereby be expanded to an expanded foam 606. The foam concentrate 604, a solution including the foam concentrate in water and the expanded foam may be generally or collectively be referred to herein as “foam.”

Next at step 712, expanded foam 606 may be discharged from a foam diffuser 202 coupled at an end of the fluid supply conduit 102. The foam diffuser 202 may be fixedly coupled to an underside 104u of the floating roof 104 and may be submerged in a flammable liquid 204 stored within the storage tank 102. As the foam 606 is discharged, the foam 606 may be further expanded by a screen 308 covering an outlet 306 of the foam diffuser 202. At step 714, the foam floats to an upper surface of the flammable liquid 204 and forms a protective foam blanket between the underside 104u of the floating roof 104 and an upper surface 204u of the flammable liquid 204. The foam blanket may cover the entire upper surface 204u to extinguish the fire 602 in a reliable, robust and efficient manner.

Embodiments disclosed herein include:
A. A fire extinguishing system can include a storage tank defining a vertical wall for retaining a flammable liquid therein and a floating roof circumscribed by the vertical wall. The floating roof can be movable vertically along the vertical wall in response to a changing level of the flammable liquid within the storage tank. A rim seal can be defined circumferentially between the floating roof and the vertical wall and a foam supply conduit can extend to the storage tank from a remote location. A foam diffuser can be fluidly coupled to the foam supply conduit and can be affixed to an underside of the floating roof. The foam diffuser can include at least one outlet for discharging a foam from the foam supply conduit into the flammable liquid adjacent the underside of the floating roof and an upper surface of the flammable liquid.
B. A method of extinguishing a fire can include (a) installing a foam supply conduit extending from a remote location to a foam diffuser affixed to an underside a floating roof circumscribed by a vertical wall of a storage tank in which a flammable liquid is stored, (b) releasing a foam concentrate into the foam supply conduit from a foam supply in response to detecting the fire, (c) discharging the foam from the diffuser into the flammable liquid and (d) forming a protective foam blanket between the underside of the floating roof and an upper surface of the flammable liquid to extinguish the fire.
C. A fire extinguishing system can include a storage tank defining a vertical wall, and a flammable liquid stored within the storage tank and a floating roof floating on an upper surface of the flammable liquid and circumscribed by the vertical wall. The floating roof can be movable vertically along the vertical wall in response to a changing level of the flammable liquid within the storage tank. A rim seal can be defined circumferentially between the floating roof and the vertical wall and a foam supply can be provided at a remote location with respect to the storage tank. A foam supply conduit can extend to the storage tank from the foam supply at the remote location and a foam diffuser can be fluidly coupled to the foam supply conduit. The foam diffuser can be submerged in the flammable liquid and affixed to an underside of the floating roof. The foam diffuser can include a backflow preventer for preventing flow of the flammable liquid into the foam supply conduit and at least one outlet for discharging a foam from the foam supply conduit into the flammable liquid adjacent the underside of the floating roof and an upper surface of the flammable liquid.

Each of embodiments A, B, and C may have one or more of the following additional elements in any combination: Element 1: further comprising a foam agitator coupled within the foam supply conduit, the foam agitator defining a central flow passage extending longitudinally therethrough and at least one lateral opening defined through a sidewall thereof for introduction of air into the central flow passage. Element 2: wherein the central flow passage defines converging and diverging portions to define a Venturi flow path through the foam agitator. Element 3: further comprising one or more fins protruding into the central flow path to mechanically agitate the foam flowing therethrough. Element 4: wherein the foam supply conduit extends over an upper end of the vertical wall and includes an adjustable-length portion between the upper end of the vertical wall and the floating roof, the adjustable-length portion adjustable in length in response to vertical movement of the floating roof. Element 5: wherein the adjustable-length portion includes at least one of a bellows, a flexible coil and a plurality of telescoping segments. Element 6: wherein the diffuser includes a housing abutting the underside of the floating roof, and wherein the at least one outlet is defined within the housing. Element 7: wherein a screen extends across the at least one outlet, the screen including a perforated panel or a wire mesh. Element 8: further comprising a check valve or a backflow preventer within the diffuser to prevent a flow of the flammable liquid into the foam supply conduit. Element 9: further comprising a dike surrounding the storage tank and defining a basin therein, wherein the remote location from which the foam supply conduit extends is outside the dike. Element 10: further comprising a foam supply coupled to the foam supply conduit at the remote location, the foam supply including at least one of a low expansion protein foam, aqueous film forming foam, film forming fluoro-protein foam or a synthetic foam.

Element 11: further comprising agitating the foam in a foam agitator coupled within the foam supply conduit, wherein agitating the foam includes injecting or drawing atmospheric air into the foam agitator to thereby expand the foam Element 12: wherein drawing atmospheric air into the foam agitator includes flowing the foam through converging and diverging portions of a central flow passage of the foam agitator to draw the atmospheric air through lateral openings defined in a sidewall of the foam agitator. Element 13: wherein agitating the foam further comprises engaging the foam with one or more fins protruding into the central flow path to mechanically agitate the foam. Element 14: further comprising flowing the foam over an upper end of the vertical through the foam supply conduit and through an adjustable-length portion of the foam supply conduit defined between the upper end of the vertical wall and the floating roof. Element 15: further comprising passively adjusting a length of the adjustable-length portion in response to vertical movement of the floating roof caused changing fluid levels of the flammable liquid within the storage tank.

Element 16: further comprising a foam agitator coupled within the foam supply line, the foam agitator operable to draw atmospheric air into the foam supply line by flowing the foam through converging and diverging portions of a central passage extending through the foam agitator. Element 17: wherein the foam supply conduit includes an adjustable-length portion extending between an upper end of the vertical wall and the floating roof, the adjustable-length portion passively adjustable in response to changing levels of the flammable liquid within the storage tank.

By way of non-limiting example, exemplary combinations applicable to A, B, and C include: Element 1 with Element 2; Element 4 with Element 5; Element 6 with Element 7; Element 7 with Element 8; Element 9 with Element 10; Element 11 with Element 12; Element 12 with Element 13; and Element 14 with Element 15.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A fire extinguishing system, comprising:
a storage tank providing a vertical wall for retaining a flammable liquid therein;
a floating roof circumscribed by the vertical wall and vertically movable along the vertical wall in response to a changing level of the flammable liquid within the storage tank;
a rim seal defined circumferentially between the floating roof and the vertical wall;
a foam supply conduit extending to the storage tank from a remote location; and
a foam diffuser fluidly coupled to the foam supply conduit and affixed to an underside of the floating roof, the foam diffuser including at least one outlet for discharging a foam from the foam supply conduit into the flammable liquid adjacent the underside of the floating roof and an upper surface of the flammable liquid.

2. The fire extinguishing system of claim 1, further comprising a foam agitator coupled within the foam supply conduit and defining a central flow passage extending longitudinally therethrough and at least one lateral opening defined through a sidewall thereof for introduction of air into the central flow passage.

3. The fire extinguishing system of clam 2, wherein the central flow passage defines converging and diverging portions to provide a Venturi flow path through the foam agitator.

4. The fire extinguishing system of claim 3, further comprising one or more fins protruding into the central flow path to mechanically agitate the foam flowing therethrough.

5. The fire extinguishing system of claim 1, wherein the foam supply conduit extends over an upper end of the vertical wall and includes an adjustable-length portion extending between the upper end of the vertical wall and the floating roof, the adjustable-length portion being adjustable in length in response to vertical movement of the floating roof.

6. The fire extinguishing system of claim 4, wherein the adjustable-length portion includes at least one of a bellows, a flexible coil and a plurality of telescoping segments.

7. The fire extinguishing system of claim 1, wherein the diffuser includes a housing abutting the underside of the floating roof, and wherein the at least one outlet is defined within the housing.

8. The fire extinguishing system of claim 7, wherein a screen extends across the at least one outlet, the screen including a perforated panel or a wire mesh.

9. The fire extinguishing system of claim 8, further comprising a check valve or a backflow preventer within the diffuser to prevent a flow of the flammable liquid into the foam supply conduit.

10. The fire extinguishing system of claim 1, further comprising a dike surrounding the storage tank and defining a basin therein, wherein the remote location from which the foam supply conduit extends is located outside the dike.

11. The fire extinguishing system of claim 10, further comprising a foam supply coupled to the foam supply conduit at the remote location, the foam supply including at least one of a low expansion protein foam, aqueous film forming foam, film forming fluoro-protein foam or a synthetic foam.

12. A method of extinguishing a fire, the method comprising:
installing a foam supply conduit extending from a remote location to a foam diffuser affixed to an underside a floating roof circumscribed by a vertical wall of a storage tank in which a flammable liquid is stored;
releasing a foam concentrate into the foam supply conduit from a foam supply in response to detecting the fire;
discharging the foam from the diffuser into the flammable liquid; and
forming a protective foam blanket between the underside of the floating roof and an upper surface of the flammable liquid to extinguish the fire.

13. The method of claim 12, further comprising agitating the foam in a foam agitator coupled within the foam supply conduit, wherein agitating the foam includes injecting or drawing atmospheric air into the foam agitator to thereby expand the foam.

14. The method of claim 13, wherein drawing atmospheric air into the foam agitator includes flowing the foam through converging and diverging portions of a central flow passage of the foam agitator to draw the atmospheric air through lateral openings defined in a sidewall of the foam agitator.

15. The method of claim 14, wherein agitating the foam further comprises engaging the foam with one or more fins protruding into the central flow path to mechanically agitate the foam.

16. The method of claim 12, further comprising flowing the foam over an upper end of the vertical through the foam supply conduit and through an adjustable-length portion of the foam supply conduit defined between the upper end of the vertical wall and the floating roof.

17. The method of claim 16, further comprising passively adjusting a length of the adjustable-length portion in response to vertical movement of the floating roof caused changing fluid levels of the flammable liquid within the storage tank.

18. A fire extinguishing system, comprising:
a storage tank defining a vertical wall
a flammable liquid stored within the storage tank;
a floating roof floating on an upper surface of the flammable liquid and circumscribed by the vertical wall, the floating roof movable vertically along the vertical wall in response to a changing level of the flammable liquid within the storage tank;
a rim seal defined circumferentially between the floating roof and the vertical wall;
a foam supply at a remote location with respect to the storage tank;
a foam supply conduit extending to the storage tank from the foam supply at the remote location; and
a foam diffuser fluidly coupled to the foam supply conduit, the foam diffuser submerged in the flammable liquid and affixed to an underside of the floating roof, the foam diffuser including:
a backflow preventer for preventing flow of the flammable liquid into the foam supply conduit; and
at least one outlet for discharging a foam from the foam supply conduit into the flammable liquid adjacent the underside of the floating roof and an upper surface of the flammable liquid.

19. The fire extinguishing system of claim 18, further comprising a foam agitator coupled within the foam supply line, the foam agitator operable to draw atmospheric air into the foam supply line by flowing the foam through converging and diverging portions of a central passage extending through the foam agitator.

20. The fire extinguishing system of claim 18, wherein the foam supply conduit includes an adjustable-length portion extending between an upper end of the vertical wall and the floating roof, the adjustable-length portion passively adjustable in response to changing levels of the flammable liquid within the storage tank.
